(19) United States
(12) Patent Application Publication
(10) Pub. No.: US 2022/0027884 A1
(43) Pub. Date: Jan. 27, 2022

(54) Weber Process

(71) Applicant: John Robert Weber, East Brunswick, NJ (US)

(72) Inventor: John Robert Weber, East Brunswick, NJ (US)

(21) Appl. No.: 16/936,466

(22) Filed: Jul. 23, 2020

(51) Int. Cl. G06Q 20/20; G06K 7/10; G06K 19/07

(52) U.S. Cl. CPC G06Q 20/208; G06Q 20/201; G06K 2007/10504; G06K 19/0723; G06K 7/10297

(57) ABSTRACT

Weber Process invention relates to checkout registers. To be more specific, this invention pertains process of shopping and purchasing goods in wholesale, retail, and all other places of business that include placing items in a shopping cart, in a basket, or on any mechanism for transferring merchandise, such as a cart at a home improvement store for purchase. It utilizes technology of anti-theft devices such as a scanner system in opposite way. The Weber Process records pre-installed programmable data on pre-installed microchip/scanner communication device/receiver chip installed on packaging of merchandise/trade item, registers it, and totals amount for sale to customer. The Weber grid system is permanently mounted on shopping carts to allow for shopping bags to be clipped to it, for shopping bags to be clipped so they remain in an open position.

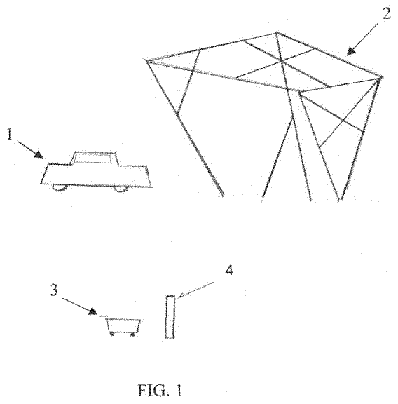

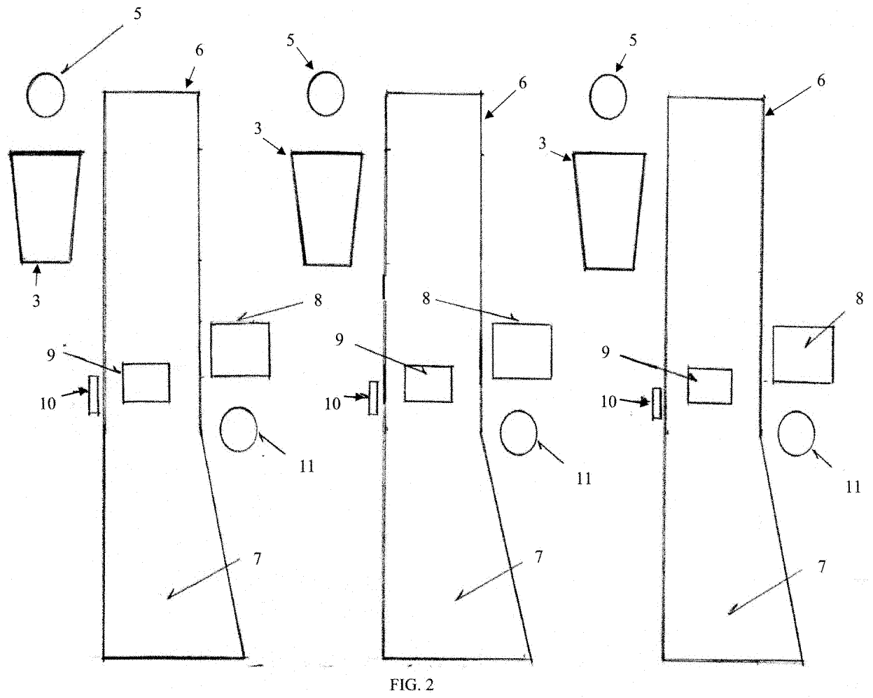

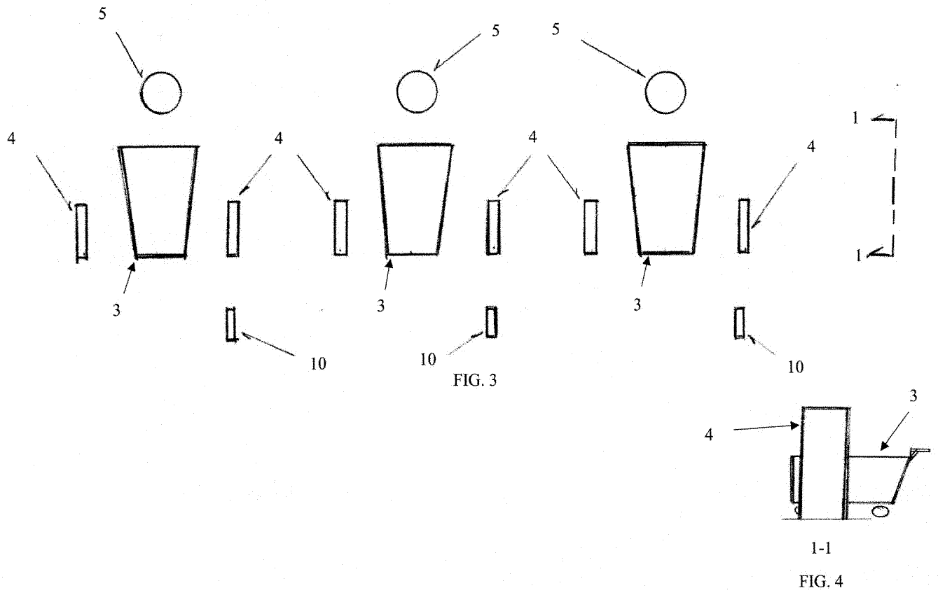

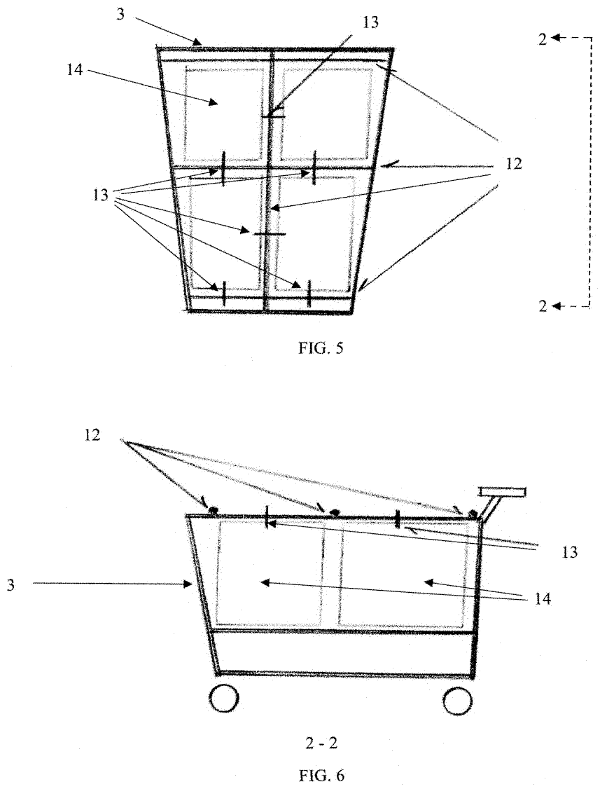

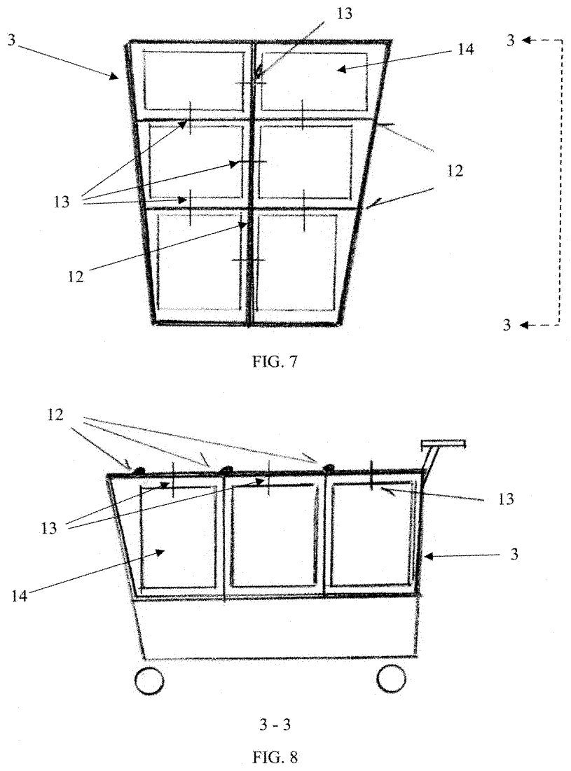

### PURPOSE

The purpose of The Weber Grid System is to make the shopping experience more efficient, productive, and to save costs. The Weber Grid System is to be utilized with the Weber Process.

### WEBER GRID SYSTEM

The purpose of the Weber Grid System is to keep shopping bags open for ease of putting merchandise in them. The cost of the Weber grid system installed on carts would be additional. The Weber grid system could be installed on existing shopping carts. The Weber grid system is permanently mounted on shopping carts to allow for shopping bags to be clipped to it. The Weber grid system is made out of metal, rubber, plastic, or any other suitable material. Clamps and screws mount the Weber grid system to existing shopping carts permanently. Clips are permanently installed on the top of the grid system to allow for shopping bags to be clipped so that that shopping bags remain in an open position.

### Gains and Benefits

The Weber Grid System allows customers to insert merchandise into an open shopping bag. A grid system of multiple squares (4, 6, 8, etc.) installed onto a shopping cart. The bags are clamped onto the Weber grid system to remain in an open position. The Weber Grid System is to be utilized with the Weber Process.

The Weber Grid System is fastened permanently to shopping carts.

The Weber Grid System is made of metal, plastic, rubber, or any other material.

### Other

The Weber Grid System is permanent clamped to the shopping cart.

The Weber Grid System utilizes clips that allow shopping bags to be clipped to the Weber Grid System.

### Weber Grid System

New Weber Grid System—Titled Weber Grid System

New Weber Grid System—Titled Weber Grid System

New Weber Grid System—Titled Grid System Installed on Shopping Cart

New Weber Grid System—Titled Grid System Installed on Shopping Cart

New Weber Grid System—Titled Grid System Installed on Shopping Cart

New Weber Grid System—Titled Grid System Installed on Shopping Cart

New Weber Grid System—Titled Cart with Bags—Weber Grid System, Grid allows bags to be clamped to grid in an open position for ease of loading.

New Weber Grid System—Titled Cart with Bags—Weber Grid System, Grid allows bags to be clamped to grid in an open position for ease of loading.

New Weber Grid System—Titled Cart with Weber Grid System, Grid allows bags to be clamped to grid in an open position for ease of loading. Baskets could also pass through scan with bag.

### Introduction

The current process for shopping and purchasing goods in supermarket grocery stores, retail stores, electronics stores, hardware stores, building supply stores, and all other stores is antiquated. The following process named The Weber Process is a more productive, more cost effective, time-saving, more accurate, and a much better process for shopping and purchasing goods in wholesale, retail, and all other places of business that include placing items in a shopping cart, in a basket, or on any mechanism for transferring the merchandise, such as a cart at a home improvement store for purchase.

### Shopping Experience

A customer of these stores arrives in the parking lot of the store and attains a shopping cart in the parking lot. The customer would proceed into the store with the shopping cart or hand basket and begin to shop for the merchandise that they would like to purchase. The customer would review the items on the store shelf, remove the item from the shelf, and place the item in the cart. The cart or basket would be filled with items as the customer moved from aisle to aisle as the customer chose new items. Once the customer is complete with the choosing phase of the shopping experience, the customer would begin to wait in line for the cashier to then purchase the items.

### Purchasing Experience

The customer waits in line until it is their turn to begin the purchasing process. The purchasing process consists of arriving at the conveyor belt and unloading all of the items in the cart or basket onto the conveyor belt. The items are moved via the conveyor belt to a cashier. The cashier asks if the customer has a shopping membership card and/or any coupons. The customer waits as the cashier performs his/her tasks. The cashier receives each of the items from the conveyor belt, handles each item to expose a universal product code (UPC) code. The UPC code, also referred to as a EAN code, GTIN, other includes a EAN bar code that is a unique identifier for trade items. The UPC code is located by the cashier as he/she handles the trade item. The cashier then scans the UPC code with a UPC scanner that registers the trade item specifically by merchandise type and cost. The type and cost of the trade item is then registered into the total cost summary into the cash register. The unique trade item label and cost is then transferred onto a receipt that the customer received once the purchasing experience is complete.

The cashier scans the trade item or merchandise while handling the item and transfers the item to another conveyor belt, table, or to another individual who bags the merchandise. This individual is known as the bagger. Either the cashier or the bagger, or both place each trade item or merchandise into a paper or plastic bag and place the item on the bagging conveyor or bagging area table. The customer then receives the bag from the cashier or the bagger and places the bag of merchandise into the shopping cart once again.

The cashier completes his/her task of totaling up all of the trade items and merchandise on the conveyor belt and summarizes the total amount due to the store. The cashier indicates to the cash register that the order totaling is complete and for the cash register to total up the cost due as a result of the purchase of trade items or merchandise. The cashier presents the customer with the total and the customer agrees to provide a form of payment for the merchandise. The customer pays for the merchandise with cash, credit card, or some other payment. If paying with a credit card, the customer provides the credit card for review to the cashier and then the customer or the cashier swipe the credit card through the card swipe, or via a credit card chip reader. The customer signs the store billing for amount due to the store and then exits the purchasing process by taking the shopping cart full of bagged merchandise out of the store.

The customer arrives outside the store and removes the bagged merchandise for transport to their home or other place.

### The Weber Process

Since approximately 1974, merchandise purchased at these stores formerly was priced using a pricing gun or label maker. Also, reference U.S. Pat. No. 2,612,994. The merchandise was unloaded from shipping boxes in the store by the employee of the organization. The merchandise was priced utilizing this pricing gun or label maker by sticking a label that included the price on the merchandise. The merchandise was then placed on a store shelf by an employee of the organization. The merchandise or trade item was then reviewed by the customer on the shelf and placed in a shopping cart. The merchandise was then purchased via the purchasing process listed above. The cashier during this time period required great skill in both thought and function. The cashier was more productive depending on how quickly he/she handled the trade item, read the price, transferred the price via key strokes into a cash register, and then moved the trade item to the bagging conveyor or area.

Merchandise purchased at these stores currently utilizes the UPC and scanning method. The merchandise was unloaded from shipping boxes in the store by the employee of the organization. The merchandise already includes a pre-printed UPC label with an EAN bar code, or GTIN identifier included on the packaging. The merchandise was then placed on a store shelf by an employee of the organization. The merchandise or trade item was then reviewed by the customer on the shelf and placed in a shopping cart. The merchandise was then purchased via the purchasing process listed above. The cashier during this current time period requires skill in both thought and function. The cashier is more productive depending on how quickly he/she handled the trade item, locates the UPC/EAN/GTIN label, and scans the item, and then moved the trade item to the bagging conveyor or area.

The Weber process is a further improvement in the area of the purchasing process of trade items and merchandise. Merchandise purchased at these stores could be as follows.

### The Weber Shopping Process

The customer arrives at the store parking lot and attains a shopping cart. The customer has shopping bags or attains shopping bags at the store. The customer sets up the shopping bags in the shopping cart. The shopping cart could include a grid system that the bags are clipped to so that the bags stay open and so that the process of placing the trade items and merchandise into each bag is easier.

The customer enters the store with the shopping cart with bags already in place inside the cart. The merchandise to be purchased has already been unloaded from shipping boxes in the store by the employee of the organization. The merchandise is priced already with a pre-installed microchip/scanner communication device/receiver chip installed on the packaging of the trade item. The merchandise or trade item was then reviewed by the customer on the shelf and placed in a shopping bag in the cart. Once the shopping process is complete by the customer, the Weber purchasing process begins.

### The Weber Purchasing Process

The trade items and merchandise is currently in the shopping bags inside the shopping cart. The customer enters the purchasing area. The purchasing area consists of upright scanners that scan and register the trade item cost by reading the pre-installed microchip/scanner communication device/receiver chip that is already installed on the packaging of the trade item. The customer passes through the scanner with their shopping cart and all of the trade items and merchandise in the cart are registered.

The customer pays for the merchandise with cash, credit card, or some other payment. If paying with a credit card, the customer provides the credit card. The customer swipes the credit card through the card swipe, or via a credit card chip reader. The customer signs the store billing for amount due to the store and then exits the purchasing process by taking the shopping cart full of bagged merchandise out of the store.

The customer arrives outside the store and removes the bagged merchandise for transport to their home or other place.

Initially in the Weber Process, one store supervisor may be present to oversee the purchasing process. Once the customers become familiar with the process, no human cashier may be required at the purchasing process, even for cash sales. For credit card sales, no human (other than the customer), would need to be present for the entire purchasing process.

The Weber Process can be implemented in grocery, supermarket, retail, home supplies, hardware, and all stores.

The Weber Process can be utilized in the United States and Internationally.

Basically, the Weber Process utilizes the technology of anti-theft devices such as a scan-o-matic system in the opposite way. Instead of avoiding the trade items and merchandise from passing through the upright scanners by sounding an alarm set of by the pre-installed microchip/scanner communication device/receiver chip installed on the packaging of the trade item as it is detected by the upright scanner, the Weber Process records the pre-installed programmable data on the pre-installed microchip/scanner communication device/receiver chip installed on the packaging of the trade item, registers it, and totals this amount for sale to the customer.

### Gains and Benefits

The Weber Process removes the process of loading the merchandise to the conveyor belt, handling by cashier, manual scanning process, transfer of merchandise to bagging area, bagging of merchandise, transfer of bags full of merchandise back into the shopping cart.—saves double and sometimes triple handling of merchandise, avoids injury as a result, saves time, cost effective.

Removes cashier—saves compensation, avoids injury due to handling merchandise, etc.

Removes bagger—saves compensation, avoids injury due handling merchandise, etc.

Removes conveyor belt area—saves space, saves purchase and maintenance cost, etc.

Removes bagging area—saves space, saves purchase and maintenance cost, etc.

Removes cash register—saves space, saves purchase and maintenance cost, etc.

### Other

Credit card swipe and chip reader process remains. This could be utilized for all purchases. The cost of the upright scanners would be similar to the cost of the existing scanner system.

### Weber Process

Existing Shopping Process System Sketch—Titled Existing System

Existing Shopping Process Pictures—Titled Example of checkout stations—Retail

Existing Shopping Process Pictures—Titled Example of checkout stations—Retail

Existing Shopping Process Pictures—Titled Supermarket/Grocery Store

Existing Shopping Process Pictures—Titled Retail Store

Existing Shopping Process Pictures—Titled Retail Store

Existing Shopping Process Pictures—Titled Example of checkout stations—Retail

Example of Pricing Gun and Sticker Process—Titled Example of Pricing Gun, Grocery Store Supermarket Employee Manager

Example of Pricing Gun and Sticker Process—Titled Example of Pricing Gun and Pricing Sticker

Example of Pricing Gun and Sticker Process—Titled Example of Pricing Sticker—Retail. Item

Example of UPC/EAN/GTIN Process—Titled Example of UPC Symbol—Retail Item

Example of UPC/EAN/GTIN Process—Titled Example of UPC/EAN/GTIN Symbol—Television

Example of UPC/EAN/GTIN Process—Titled Example of UPC/EAN/GTIN Symbol—Television

Example of UPC/EAN/GTIN Process—Titled Example of UPC/EAN/GTIN Symbol—Pretzels

Example of UPC/EAN/GTIN Process—Titled Unique Identifier Example

New Weber Process Shopping Process System Sketch—Titled New Weber System

New Weber Process Shopping Process System—Titled Upright Scanner Example

New Weber Process Shopping Process System—Titled Upright Scanner Example

New Weber Process Shopping Process System—Titled Weber Communication Device

New Weber Process Shopping Process System—Titled Weber Communication Device

New Weber Process Shopping Process System—Titled Weber Communication Device

New Weber Process Shopping Process System Sketch—Titled EZ Toll Scanner System and Weber Process Scanner System

New Weber Process Shopping Process System—Titled EZ Toll Communication Device and Weber Process Communication Device

New Weber Process Shopping Process System—Titled EZ Toll Communication Device and Weber Process Communication Device

New Weber Process Shopping Process System—Titled EZ Toll Communication Device and Weber Process Communication Device

New Weber Process Shopping Process System—Titled EZ Toll Communication Device and Weber Process Communication Device

New Weber Process Shopping Process System—Titled EZ Toll Communication Device and Weber Process Communication Device

New Weber Process Shopping Process System—Titled Weber Communication Device Installed on Merchandise

New Weber Process Shopping Process System—Titled Weber Communication Device Installed on Merchandise

New Weber Process Shopping Process System—Titled Weber Communication Device Installed on Merchandise

New Weber Process Shopping Process System—Titled Cart with Bags, Weber Process allows merchandise to be loaded into cart once.

New Weber Process Shopping Process System—Titled Basket with Bags, Weber Process allows merchandise to be loaded into basket once.

1. I claim solely and individually all rights to the ideas and property included in patent application Ser. No. 16/936,466, “The Weber Process” which applicant regards as his invention. The ideas and property included in this application Ser. No. 16/936,466 are distinct from any other idea and property. The invention that is “The Weber Process” is utilizing a retail shopping experience of placing the “Weber Communication Device” on retail goods and then the retail goods are placed in a shopping basket or shopping cart that has a shopping bag attached via the “The Weber Grid”. As the basket or cart pass through the scanner system, the scanners scan the “Weber Communication Device” to total the customers amount due.

2. I claim solely and individually all rights to the idea and process of the shopping experience of placing the “Weber Communication Device” on goods and then the retail goods are placed in a shopping basket or shopping cart that has a shopping bag attached via the “Weber Grid System”. As the basket or cart pass through the scanner system, the scanners scan the “Weber Communication Device” to total the customers amount due. This idea and process are separate and distinct from any other idea and property and is the property of the applicant/inventor. The applicant regards this as his invention.

3. I claim solely and individually all rights to the idea and process of the shopping experience of placing a microchip/scanner communication device/receiver chip on goods and then the retail goods are placed in a shopping basket or shopping cart. As the basket or cart pass through the scanner system, the scanners scan the microchip/scanner communication device/receiver chip. This idea and process are separate and distinct from any other idea and property and is the property of the applicant/inventor. The applicant regards this as his invention.

4. I claim solely and individually all rights to the idea and process of having a set code/value/cost installed on a microchip/scanner communication device/receiver chip to allow for a scanner system to individually read/identify the set code/value/cost of each item. The process of having a set code/value/cost installed on a microchip/scanner communication device is separate and distinct from any other idea and property. The applicant regards this as his invention.

5. I claim solely and individually all rights to the idea and process of installing a microchip/scanner communication device/receiver chip onto merchandise. This idea and process of installing a microchip/scanner communication device onto merchandise is separate and distinct from any other idea and property and is the property of the applicant/inventor. The applicant regards this as his invention.

6. I claim solely and individually all rights to the idea and process of a scanner system reading/identifying the individual identifier/cost of the value of merchandise recorded on a microchip/scanner communication device/receiver chip installed onto merchandise to allow for the scanner system to individually read/identify the cost of each item. The process of the scanner system reading/identifying the individual identifier/cost of the value of merchandise is separate and distinct from any other idea and property. The applicant regards this as his invention.

7. I claim solely and individually all rights to the idea and process of a scanner system/central computer totaling the value/cost of multiple individual identifiers/costs of the value of multiple merchandise. The process of the scanner system/central computer totaling the value of multiple merchandise is separate and distinct from any other idea and property. The applicant regards this as his invention.

8. I claim solely and individually all rights to the idea and process of a grid system on shopping carts to allow shopping bags to remain open for the purpose of placing merchandise into them. This idea and process is separate and distinct from any other idea and property and the applicant regards this as his invention. The applicant regards this as his invention.

9. I claim solely and individually all rights to the idea and process of installing a grid system on shopping carts to allow shopping bags to remain open for the purpose of placing merchandise into them. The grid system can be installed at time of shopping cart manufacture and/or the grid system could be installed after shopping cart manufacture (retrofit). This idea and process is separate and distinct from any other idea and property. The applicant regards this as his invention.
